(19) United States
(12) Patent Application Publication
(10) Pub. No.: US 2007/0136456 A1
(43) Pub. Date: Jun. 14, 2007

(54) Method and system for efficiently handling navigational state in a portal application

(76) Inventors: Stefan Behl, Backnang (DE); Carsten Leue, Sindelfingen (DE); Falk Posch, Holzgerlingen (DE)

Correspondence Address: LOTUS AND RATIONAL SOFTWARE;McGuinness & Manaras LLP, 125 NAGOG PARK, ACTON, MA, 01720, US

(21) Appl. No.: 11/299,451

(22) Filed: Dec. 9, 2005

Related U.S. Application Data
(60) Provisional application No. 60/748,699, filed on Dec. 8, 2005.

(51) Int. Cl. G06F 15/173

(52) U.S. Cl. 709/224; 709/223

(57) ABSTRACT

The present invention provides a method, system, and computer program product for efficiently handling navigational state by encoding the navigational state into each URL of a page. The navigational state is encoded in such a way that it can be easily decoded from the URL in order to restore the addressed view of the Portal and that allows for further navigation start from that view. Each user interaction uses an URL in a Portal page containing the navigational state consisting of a part that is identical across all URLs on that page and an additional part which represents the semantic of each specific URL. In a preferred embodiment of the present invention the internal representation of navigational state is laid down in a hierarchical tree-like structure for serialization purposes. The hierarchical tree-like structure is based on a well-defined state model that is optimized in terms of state serialization. The state model arranges the contained navigational state information in character based information. That saves processing time as it avoids type conversion of navigational information. A further embodiment of the present invention includes further strategies to reduce the amount of information that must be serialized.

### CROSS REFERENCE TO RELATED APPLICATIONS

This application claims benefit under 35 U.S.C. 119(e) to Provisional U.S. application entitled “A Method for Efficiently Representing Navigational State in a Web Application”, filed Dec. 8, 2005, and having attorney docket number 260-056.

### FIELD OF THE INVENTION

The present invention relates to a method and system for efficiently handling navigational state in a Portal application and in particular to maintain the navigational state across all user interactions on a Portal application.

### BACKGROUND

Navigational state as used by the present invention describes the “current view of the Portal that is the result of all previous navigational interactions of a particular client”. The client can request (query) different views by interacting with the Portal page, e.g. by navigating to a new page. This type of interaction does not change server side state but only requests a new view of the server; it is therefore a “safe” operation in terms of HTTP. The nature of this interaction is such that the client can navigate back and forward through its recent views using the back and forward button of his browser and that clients can bookmark views and get back to them at a later point in time by invoking a browser bookmark.

One of the main features of HTTP is that it is a stateless protocol i.e. the notion of a session spanning multiple request/response interactions does not exist in HTTP. But as nearly all application scenarios require some mechanism to save their state across requests some mechanisms have emerged that allow for creating (logical) stateful sessions and that can be certainly considered as state of the art nowadays. The two most popular state prior art saving mechanisms are the following:

To initiate a logical session between the client (typically a browser) and the server, the server returns an extra “set-cookie” response header to the client containing basically name value pairs. The client stores the cookie persistently in a file and associates it with the server's URL. With each request, the client provides this cookie back to the server using the “cookie” request header. By analyzing the cookie, the server (not the HTTP server but the application or a server-side script such as a servlet or CGI) can identify the user-specific session containing the needed state information. Note that cookies also allow for maintaining state across session boundaries as the persistent cookie file on the client typically lives longer than the corresponding session on the server.

This second variant exchanges the complete state information between server and client. The server stores the state in the markup of the requested page using a hidden input file of a (HTML) form. In addition, the application makes sure that each URL in the markup of a page initiates a form submit causing the state being part of the hidden input field to flow along with the request to the HTTP server.

In today's Web applications even navigational state is mostly saved across requests using one of the outlined mechanisms. However, both approaches have some major drawbacks with regard to bookmarkability, caching, back/forward button, and indexing by search engines (“crawlability”). Storing the navigational state in a logical server-side HTTP session (e.g. identified via a cookie) has the following disadvantages:

Browser bookmarks do not work as the navigational state kept in the server-side session has only a limited lifetime. Typically the session times out after a period of inactivity. After a session timeout, the navigational state cannot be restored on the server i.e. the server will deliver a default view on the application.

Navigating back and forward through the recent views using the back and forward button of the browser does not work. Note that the state does not get lost in that case as long as the session is maintained but the operations of the back and forward button do not take any effect on that state.

The benefits of caching (browser-side, server-side, and proxy caching) are considerably reduced as such caches typically use the URL as their cache key.

Web search engines cannot index the site well. Search engines work by storing information about a large number of Web pages which they retrieve from the Web itself. These pages are retrieved by an automized Web browser called “Web crawler” that follows every URL/URL it sees on the page (in the markup respectively).

Storing the navigational state in a hidden input field of a HTML form has less disadvantages but it also does not solve all problems summarized. Bookmarkability works as long as the respective page is cached. The back and forward button works. The caching and crawlability problem remains. Note that state management relying on hidden input fields cannot be applied in the Portal area as the mechanism requires a page-level form. However, a page level form cannot be used the markup of JSR 168 compliant portlets may also make use of HTML forms thus causing nested forms (forbidden by the HTML standard).

It is object of the present invention to provide a method and system for efficiently handling navigational state of a Portal avoiding the disadvantages of the existing prior art.

### SUMMARY OF THE INVENTION

The present invention provides a method, system, and computer program product for efficiently handling navigational state by encoding the navigational state into each URL of a Portal page. The navigational state is encoded in such a way that it can be easily decoded from the URL in order to restore the addressed view of the Portal and that allows for further navigation start from that view.

Each user interaction uses an URL containing the navigational state consisting of a part that is identical across all URLs on that page and an additional part which represents the semantic of each specific URL. In other words each,URL contains the target navigational state that should be rendered when clicking on that URL. During the rendering phase the target navigational state of each URL that is part of the rendered page is newly calculated and serialized to the respective URL. In a preferred embodiment the navigational state is internally represented in a hierarchical tree-like structure for serialization purposes.

The hierarchical tree-like structure of the preferred embodiments is based on a well-defined state model that is optimized in terms of state serialization. The state model arranges the contained navigational state information in character based information. That saves processing time as it avoids type conversion of navigational information. In addition the preferred embodiment includes further strategies to reduce the amount of information that must be serialized.

### BRIEF DESCRIPTION OF THE DRAWINGS

The above, as well as additional objectives, features and advantages of the present invention will be apparent in the following detailed written description.

The novel features of the invention are set forth in the appended claims. The invention itself, however, as well as a preferred mode of use, further objectives, and advantages thereof, will be best understood by reference to the following detailed description of an illustrative embodiment when read in conjunction with the accompanying drawings, wherein:

FIG. 1 shows a screenshot of a Portal in which various parts of UI making up the navigational state of this particular view are highlighted,

FIG. 2A shows a preferred Portal structure implementing the present invention,

FIG. 2B shows an interaction diagram of a preferred embodiment of the method for efficiently handling navigational state according to the present invention in a Portal according to FIG. 2A,

FIG. 2C-D show exemplary representations of the navigational state (state document) according to the present invention, and

FIG. 2E shows an exemplary mapping table for a state document as shown in FIG. 2D.

### DETAILED DESCRIPTION OF EXEMPLARY EMBODIMENTS

The basic idea of the present invention is to provide a method and system for efficiently handling navigational state by encoding the navigational state into each URL of a Portal page. Each user interaction uses an URL containing the navigational state consisting of a part that is identical across all URLs on that page and an additional part which represents the semantic of each specific URL.

In a preferred embodiment the navigational state is internally represented in a hierarchical tree-like structure for serialization purposes.

The hierarchical tree-like structure is based on a well-defined state model that is optimized in terms of state serialization. The state model arranges the contained navigational state information in character based information. That saves processing time as it avoids type conversion of navigational information.

The further preferred embodiment includes further strategies to reduce the amount of information that must be serialized.

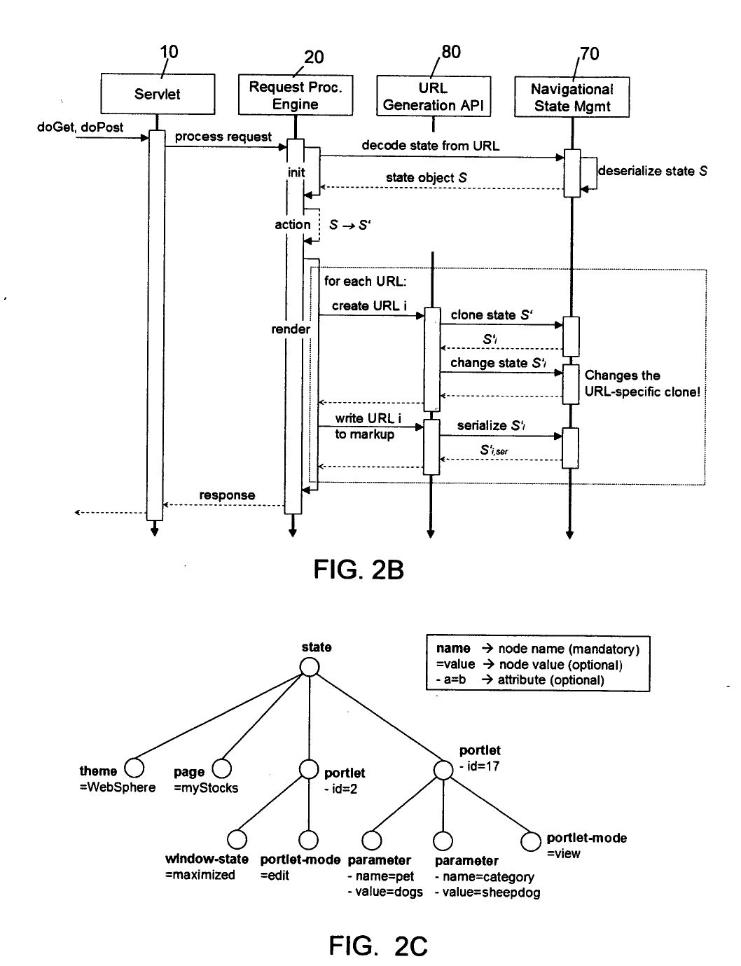

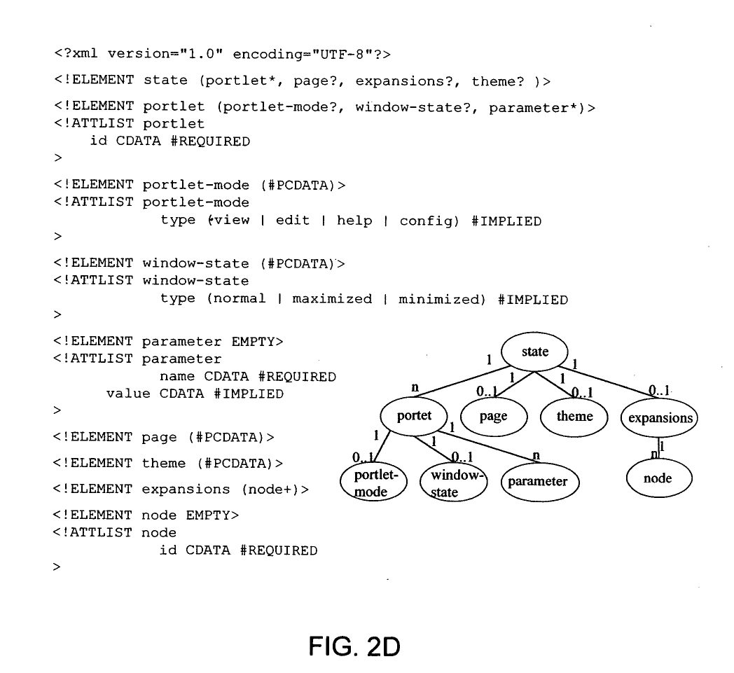

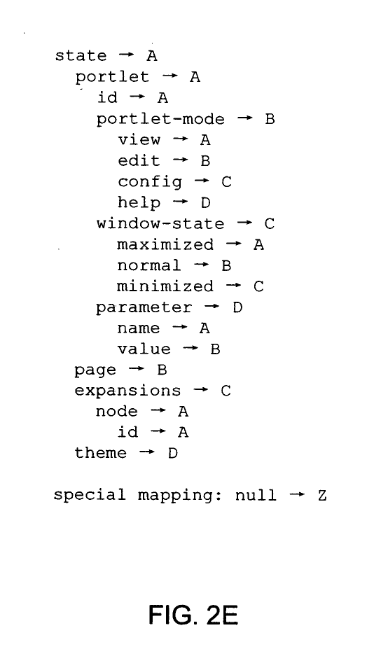

The present invention is implemented in Portal which is described in connection with FIG. 2A. At the client side no changes are required.

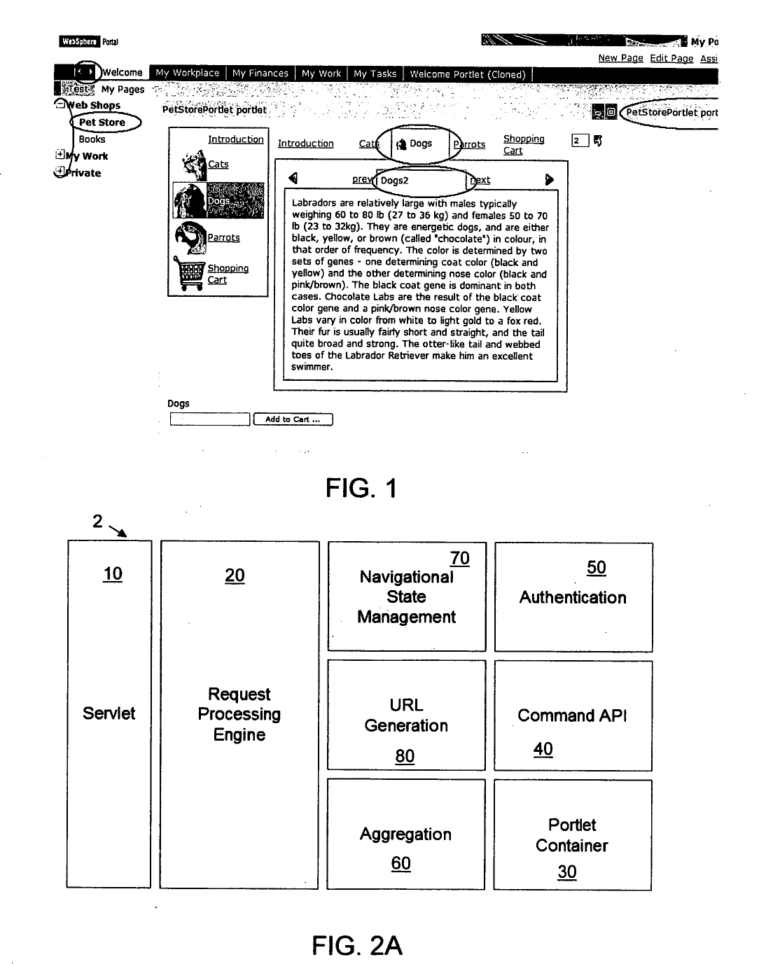

FIG. 1 briefly describes an example of a screenshot of a Portal in which the various parts of the UI making up the navigational state of this particular view are highlighted. The illustrated page comprises means to navigate Portal pages (the tabbed pane at the top as well as the left-side tree control), administrative toolbars (“New Page”, “Edit Page”), and the actual Portal page offering Portlets. In this case, the user has selected the “Pet Store” page offering two pet store Portlets. The navigational state of this particular view involves the selected page (“Pet Store”), the set of collapsed navigation URLs in the left-side tree control (“My Work” and “Private”), the minimized Pet Store Portlet on the right, the selected pet (“Dogs”) in the right Pet Store portlet, and the selected tab (“Dogs2”) of the tabbed pane nested inside the Dogs tab. Each URL that is offered on the displayed page encodes the complete navigational state including a piece of information that specifies what change the URL should cause when clicked. For example if the user switches to the page “Books” and then returns to the “Pet Store” page, he or she will encounter the page with the “Dogs” and nested “Dogs2” tab still selected.

FIG. 2A shows the preferred Portal structure implementing the present invention.

The Portal structure comprises function components which are already part of each prior art Portal and those components which are newly added in order to provide the inventive functionality. The prior art function components which are being part of each Portal are following:

The Servlet 10 is the front controller that receives the incoming HTTP requests. It typically prepares the request processing engine 20 for processing the received HTTP request by initializing the components involved. After that the servlet 10 delegates the processing of the request to the request processing engine 20.

Request Processing Engine 20

The request processing engine 20 is also part of the front controller being responsible for controlling the processing of the incoming requests. Typically it defines a request processing lifecycle that is made up of several request processing phases. In the Portal 2 a request has to walk through four phases. First, the init phase performs request-specific initialization tasks followed by the action phase being responsible for authentication and action execution (Portlet actions as well as commands). After the action phase the render phase is executed by invoking the aggregation process. The terminal phase concludes request processing by performing request-specific cleanup tasks.

Aggregation Component 60

The aggregation component 60 is invoked during the render phase of the request processing lifecycle. It is responsible for transforming the layout model of the requested page into a presentation tree as well as writing the markup that corresponds to this presentation tree to the response.

Authentication Component 50

The authentication component 50 is responsible for verifying the identity of the user. Each incoming request has to pass authentication. The Portal 2 uses the user identity to determine the content the user is authorized to access as well as the commands to execute.

Portlet Container 30

The Portlet container 30 provides unified access to the Portlets. In particular it allows for gathering the markup of a certain Portlet or executing a Portlet action. The Portlet container invokes Portlets by means of the Portlet API.

Command API

The command API 40 (application programming interface) provides an abstraction layer for Portal-specific commands. In particular it allows for executing commands via a unified interface. Commands may be used to perform administrative tasks such as creating and/or deleting Portal pages, adding and/or removing Portlets to and/or from Portal pages, arranging Portlets on existing pages and so on.

The newly added function components that provide the inventive functionality are following:

Navigational State Management Component 70

The navigational state management component is the key component realizing the present invention in the Portal 2. The responsibilities of this new component are the following: defining a lifecycle for navigational state as well as providing an interface that enables the request processing engine 20 to incorporate the defined state processing tasks into the overall request processing lifecycle, defining an object model to represent navigational state as well as providing an application programming interface (API) that allows for reading and writing/modifying navigational state, providing a framework that allows for efficiently serializing the object representation of navigational state into an URL as well as de-serializing navigational state from an (incoming) URL to restore the internal object representation. The framework needs to include interfaces that can be invoked by the URL generation component to create URLs carrying navigational state,

URL Generation API 80

The URL generation API 80 provides, as the name implies, an API that allows for creating URLs for a variety of use cases. It enables the programmer to associate navigational state with the created URL as well as to write the URL to a given destination stream. This write operation involves serializing the navigational state that has been associated with the created URL. In addition to creating URLs programmatically, the URL generation API 80 typically offers some URL tags to create URLs within JSPs.

Note that by default a created URL is initialized with the request-specific navigational state to make sure that the navigational state of previous interactions does not get lost. To determine the specific semantics of the URL this navigational state may be changed for this particular URL only.

FIG. 2B shows an interaction diagram of a preferred embodiment of the method for efficiently handling navigational state in a Portal according to FIG. 2A.

First the servlet 10 hands the received HTTP request over to the request processing engine 20. The request processing engine initiates the request processing lifecycle starting with the init phase.

Init Phase

During the init phase the URL portion representing navigational state is retrieved from the incoming request URL (typically from the URL's path info) and initiates state decoding. State decoding is performed by the navigational state management component 70. It basically involves de-serializing the navigational state into the internal state object representation S. All subsequent request processing tasks operate on this object representation.

Action Phase

During the action phase all “actions” that are associated with the current request are processed. This includes authentication, portlet actions, and commands (to keep clearness these steps are not illustrated in the diagram). Note that actions may modify the request-specific navigational state object S obtained from the init phase. Let S′ be the result of these state modifications. After action processing is completed the request processing engine 20 moves to the render phase being responsible for producing the markup that corresponds with the requested view (navigational state).

Render Phase

The render phase basically delegates the rendering task to the aggregation component. The aggregation component determines the layout of the requested Portal page and invokes the rendering of the various page elements (navigation controls, toolbars etc.) including the Portlets via the Portlet container.

The URLs that should be included into the markup of the respective page element or Portlet are created via the URL generation API, i.e. either programmatically or via JSP tags. Under the covers the URL generation component changes the navigational state S′ according to the invocation of the API (the passed arguments etc.) to express the semantics of the respective URL. As these changes should only take effect for the particular URL only, the URL generation component actually operates on an URL-specific state clone S′.

The discussed first embodiment describes a simple way to encode navigational state into URLs.

The internal representation of navigational state is preferably made in an object model. Choosing a suitable object representation is crucial to tune the single steps of encoding navigational state into each URL according to the present invention. The recommended design is based on the assumption that a typical Portal page contains a lot of URL i.e. the object representation of navigational state must be optimized in terms of state serialization. Applying this assumption to the teaching of the present invention means that the object representation must allow for efficiently recording and serializing navigational state.

In a preferred embodiment of the present invention it is taught to model navigational state using a hierarchic document model containing un-typed state information represented as characters (or Strings in terms of Java).

The character-based memory representation allows to efficiently serialize navigational state into URLs, because it avoids time and CPU consuming object to string conversions during the serialization process.

FIG. 2C shows an exemplary simplified document model. It contains the navigational state of just two Portlets and in addition page selection information as well as theme information. In a realistic business scenario a Portal page typically aggregates multiple navigation controls, toolbars, and portlets (up to 20 portlets in average) potentially making the state document much more complex.

One of the common object-oriented design patterns is to separate read-only interfaces from read-write interfaces (controllers). Accordingly, the used object model should offer two interfaces to the state document.

The DocumentModel interface provides read-access to the state document offering the following methods (UML notation):
getRoot( ): Node—Returns the root node of the state document,
getchildren(parent: Node): List—Returns a list of nodes, and representing the child nodes of the given parent,
getParent(node: node): Node—Returns a node representing the parent of the given node. If the given node corresponds with the document root, the method will return null,
other methods such as hasChildren, hasAttributes, and
getAttributes. The DocumentController interface provides read-write access i.e. it additionally allows for modifying the hierarchic state document.

The DocumentController interface offers the following methods:
insert(new: Node; next: Node; parent: Node): Node—Inserts the given node newNode into the state document at the specified position,
remove(node: Node): Node—Removes the given node from the state document,
create(namespace: String; name: String): Node—Creates a new node with the given name and namespace and returns the created Node object. Subsequently the created node can be inserted into the state hierarchy using the insert method,
other methods such as setvalue, addAttribute, setAttributes, removeAttribute, and clearAttributes.

The used interface Node models a single node in the document model hierarchy. This node is not aware of its position in the hierarchy or of its attributes, but only of its content.

The Node interface offers the following methods:
getNodeName( ): String—Returns the qualified name of the node.
getNodeValue( ): String—Returns the value of the node.
getNamespaceURI: String—Returns the namespace URI of the node.

The interface can be applied to the sample state shown in FIG. 2C.

Serializing The Navigational State

When serializing the navigational state, the complete state document has to be serialized to be included into URLs during rendering. The needed serialization mechanism has to serialize the minimal information (the so-called “entropy”) that is needed to restore (de-serialize) the complete state document when receiving an URL. This includes the document structure, i.e. parent child relationships, and the document content data, i.e. node names, values, and attributes. To keep the URLs short, this information has to be encoded as compact as possible. A compact encoding of the document structure can be achieved by using a simple bit encoding that writes the level of each element (the depth relative to the root) using a given traversal algorithm (e.g. depth-first traversal). However, the document content data cannot be serialized as easy. Just traversing the state document and writing the complete information making up a node would result in an extremely long serialized form.

A preferred embodiment of the present invention is to map the node names, attribute names, and pre-defined values to short character representations. To put this into practice the structure of a state document has to be precisely specified either in a document type definition (DTD) or in a XML schema (XSD). From this specification a mapping table can be derived that can be used for state serialization and state de-serialization. The document type definition in FIG. 2D shows an exemplary structure of a state document. The included tree in FIG. 2D visualizes this structure.

The solution to create the needed mapping table is to parse the DTD and map each element name, attribute, and value found to a short character representation. However, one can also exploit the hierarchic structure of the DTD and build a corresponding hierarchic mapping tree. Taking a character set such as UTF 8 as a basis for the short character representations one can define a really complex state structure without needing to make use of character representations that are longer than one character (because the mappings need to be only unique within the set of children of a particular element).

An example of a mapping tree that corresponds with the state structure of above is shown in FIG. 2E (the hierarchy is modelled via indentations).

The figures include block diagram illustrations of methods, apparatus(s) and computer program products according to an embodiment of the invention. It will be understood that each block of the figures, and combinations of these blocks, can be implemented by computer program instructions. These computer program instructions may be loaded onto a computer or other programmable data processing apparatus to produce a machine, such that the instructions which execute on the computer or other programmable data processing apparatus create means for implementing the functions specified in the block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block or blocks.

Those skilled in the art should readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); (b) information alterably stored on writable storage media (e.g. floppy disks and hard drives); or (c) information conveyed to a computer through communication media for example using wireless, baseband signaling or broadband signaling techniques, including carrier wave signaling techniques, such as over computer or telephone networks via a modem.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative program command structures, one skilled in the art will recognize that they may be embodied using a variety of specific command structures.

1. A method for efficiently handling navigational state in a Portal, wherein said Portal is running in a server system,
wherein said server system includes a communication component which allows communication between said Portal and client's browser via a communication channel, wherein said Portal determines the layout of the requested Portal page, invokes rendering of the various page elements belonging to said Portal page, and transmits said Portal page to the client's browser for displaying, wherein at least one page element of said Portal page provides an URL functionality for initiating rendering a new page or new page element by said Portal, wherein each user interaction by clicking said URL at said page element generates a new navigational state at said Portal side, wherein the latest navigational state describes the current view of said Portal as the result of all previous navigational interactions of a particular client, wherein said at least latest navigational state is saved by said Portal,
wherein in response to a client request for a new Portal page said method is characterized by the steps of:
creating for each URL included in said new Portal page an URL specific navigational state by using said latest navigational state and updating it with its target navigational state when said specific URL is invoked,
encoding each URL specific navigational state into its assigned URL being part of said new Portal page, and
generating and transmitting a response to said client's browser including said new Portal page for displaying by said client's browser.

2. The method according to claim 1, wherein,said encoding each URL specific navigational is based on a serialization method which operates on a hierarchical tree-like object representation representing said URL specific navigational state.

3. The method according to claim 2, wherein said hierarchical tree-like object representation contains nodes which are described by name, value, and attributes being all represented by character based strings.

4. The method according to claim 3, wherein the structure and/or nodes within said structure of said hierarchical tree-like object representation is read by a read-only programming interface and modified by a read-write programming interface.

5. The method according to claim 2, wherein said serialization method is executed during the rendering of URL being part of said Portal page to be submitted to said client's browser.

6. The method according to claim 2, wherein serialization method maps pre-defined state information of node name, value, and attributes to short one character representations in order achieve a compact serialization result.

7. The method according to claim 6, wherein said serialization result is further compressed by one or more standard compression algorithms.

8. The method according to claim 7, wherein said compression algorithms are GZip, Zip, RLE.

9. The method according to claim 7, wherein said compressed serialization result is encoded into the path information of said URL.

10. A system for efficiently handling navigational state in a Portal, wherein said Portal is running in said system, wherein said system includes a communication component which allows communication between said Portal and client's browser via a communication channel, wherein said Portal determines the layout of the requested Portal page, invokes rendering of the various page elements belonging to said Portal page, and transmits said Portal page to the client's browser for displaying, wherein at least one page element of said Portal page provides an URL functionality for initiating rendering a new page or new page element by said Portal, wherein each user interaction by clicking said URL at said page element generates a new navigational state at said Portal side, wherein the latest navigational state describes the current view of said Portal as the result of all previous navigational interactions of a particular client, wherein said at least latest navigational state is saved by said Portal, wherein said system is characterized by the following components:
a component for creating for each URL included in said new Portal page an URL specific navigational state by using said latest navigational state and updating it with its target navigational state when said specific URL is invoked,
a component for encoding each URL specific navigational state into its assigned URL being part of said new Portal page, and
a component for generating and transmitting a response to said client's browser including said new Portal page for displaying by said client's browser.

11. The system according to claim 10, wherein said components are integrated into a navigational state management component.

12. The system according to claim 11, wherein said navigational state management component is part of said Portal.
